(19) United States
(12) Patent Application Publication
(10) Pub. No.: US 2024/0162023 A1
(43) Pub. Date: May 16, 2024

(54) ION GUIDE

(71) Applicant: Thermo Fisher Scientific (Bremen) GmbH, Bremen (DE)

(72) Inventor: Hamish Stewart, Bremen (DE)

(73) Assignee: Thermo Fisher Scientific (Bremen) GmbH, Bremen (DE)

(21) Appl. No.: 18/508,999

(22) Filed: Nov. 14, 2023

(30) Foreign Application Priority Data
Nov. 15, 2022 (GB) 2217040.1

(51) Int. Cl. H01J 49/06; H01J 49/24

(52) U.S. Cl. CPC H01J 49/062; H01J 49/061; H01J 49/24

(57) ABSTRACT

An ion guide comprising: an ion receiving portion configured to receive ions along a first axis and an ion outlet configured for ejection of ions from the ion guide along a second axis different from the first axis; a deflector electrode configured to receive a DC potential to deflect ions away from the first axis and towards the second axis; and a plurality of electrodes having a substantially planar surface parallel to the second axis and configured to receive RF voltages such that there is a voltage phase difference between adjacent electrodes to generate a RF field thereby, the RF field directing the deflected ions on to the second axis towards the ion outlet.

### CROSS-REFERENCE TO RELATED APPLICATION

This application claims priority to GB application 2217040.1 filed Nov. 15, 2022, and that GB application is incorporated by reference herein.

### FIELD

The disclosure relates generally to analytical instruments, and particularly an ion guide for using in such analytical instruments.

### BACKGROUND

In mass spectrometers, it is common to employ an atmospheric pressure ion source and to transport ions generated by the ion source across a vacuum interface, where they must be captured by ion guides and transported through to higher vacuum regions for processing and analysis. One device often used for the capture of ions in this first low vacuum interface region is an ion funnel. This utilises a stack of RF electrodes with a conical bore that narrows to a final aperture to allow ions to progress to a downstream element. The stacked electrodes generate a strong repulsive pseudopotential proximate to the electrodes, so that the ions that enter the bore from a vacuum interface aperture or capillary are focused down into a narrow beam on exit. However, ion funnels, whilst commonly used for ion capture and transport, have several disadvantages.

U.S. Pat. No. 8,581,181 describes an ion guide comprising a first ion guide conjoined with a second ion guide. Ions are urged across a radial pseudo-potential barrier that separates the two guiding regions by a DC potential gradient. However, this device suffers from similar disadvantages to those of ion funnels.

In view of the above, an ion guide and method for operating an ion guide that overcomes the issues is desirable.

### SUMMARY

Against this background, there is provided a method and an ion guide. Additional aspects of the invention appear in the description and claims.

In accordance with a first aspect, there is an ion guide comprising:
an ion receiving portion configured to receive ions along a first axis and an ion outlet configured for ejection of ions from the ion guide along a second axis different from the first axis;
a deflector electrode configured to receive a DC potential to deflect ions away from the first axis and towards the second axis; and
a plurality of electrodes having a substantially planar surface parallel to the second axis and configured to receive RF voltages such that there is a voltage phase difference between adjacent electrodes to generate a RF field thereby, the RF field directing the deflected ions on to the second axis towards the ion outlet.

The plurality of electrodes may also be referred to as a set of electrodes.

The ions may be unconstrained as they travel along the first axis. For example, the ions may travel along the first axis with a velocity resulting from gas forces only. As the ions are directed on to the second axis, the ions may then be constrained by an RF pseudopotential surface generated by the plurality of electrodes when RF voltages are received or applied.

The ion guide of the first aspect may have a number of advantages. For example, the ion guide may be less complex and expensive to manufacture than a conventional ion funnel. The ion guide may also provide a less complex structure for separating ions from neutral, adducts and other undesirable molecules.

Preferably, the deflector electrode and the plurality of electrodes may be separated in a direction. The separation of the deflector electrode and the plurality of electrodes may also vary along the ion guide. In other words, some of the plurality of electrodes may be closer to the deflector electrode in the direction than other electrodes of the plurality of electrodes. The direction may be one of an x-, y-, or z-axis.

Varying the separation of the deflector electrode and the plurality of electrodes may allow for greater control of the DC gradient within the ion guide. For example, the deflector electrode may be closer to electrodes near an ion outlet than electrodes near an ion inlet or ion receiving portion. This may strengthen the DC field near the ion outlet, which may mean that ions can be better focussed near the ion outlet. This may in turn mean that a small or smaller aperture can be used as the ion outlet.

Preferably, the deflector electrode may comprise a first section and a second section and the separation of the first section and the plurality of electrodes is greater than the separation of the second section and the plurality of electrodes. Thus, the ion guide may provide similar functionality as an ion funnel without requiring complex manufacture.

Preferably, the first and second sections may be separated in the direction and may be provided on either side of the first axis such that undeflected molecules pass between the first section and the second section, and the deflected ions pass between the second section and the plurality of electrodes. In other words, the deflector electrode may have a “shelf” or “shelved” structure, such that molecules (for example, neutrals and other unwanted adducts) that are not deflected by the deflector electrode continue along the first axis to pass above the shelf. Ions that are deflected by the deflector electrode and directed on to the second axis continue along the second axis to pass below the shelf.

Thus, molecules that might otherwise contaminate the set of RF electrodes (potentially resulting in undesired charge effects that may affect results obtained by the analytical device) can be separated from the ions in a straightforward manner. Therefore, contamination of the ion guide can be reduced without requiring a complex structure or complex and/or expensive manufacturing steps.

Optionally, the deflector electrode may be inclined with respect to the plurality of electrodes or the deflector electrode may be curved to vary the separation. In other words, the deflector electrode may be provided at a non-zero angle relative to the planar surface of the plurality of electrodes or the deflector electrode may be an arcuate electrode. This may provide a simple arrangement for controlling the DC gradient along the ion guide.

Preferably, the first and second axes may be separated in the direction. This may further reduce any contamination of the plurality of electrodes and improve the ease of separation of the ions from undeflected molecules.

Preferably, the first axis may be parallel to the second axis. This may simplify the manufacture and operation of the ion guide.

Preferably, the plurality of electrodes may be arranged in a plane parallel to the second axis. This may provide a less complex structure and may better allow the generated RF field to direct ions on to the second axis.

Optionally, the deflector electrode may be a plate electrode. Preferably, the plate electrode may have a plane parallel to the first axis. This may provide a simple arrangement for deflecting ions off the first axis. The plate electrode may also be easier to clean than other electrode structures for deflecting ions.

Preferably, the plurality of electrodes may comprise a plurality of stacked electrodes or a plurality of PCB electrodes. Either option may allow for a large number and/or a higher density of electrodes to be used. PCB electrodes may be cheaper and easier to manufacture, as well as easier to clean, than stacked ring electrodes used in a conventional ion funnel.

Optionally, the ion guide may further comprise a DC electrode between one or more pairs of the plurality of electrodes. The DC electrode may be configured to receive a DC potential to direct the ions along the second axis towards the ion outlet. Thus, there may be a less complex structure for directing ions along the second axis.

Preferably, an arrangement of the plurality of electrodes may extend in a dimension perpendicular to the direction, and wherein the extension of the arrangement progressively decreases. This may allow the confinement of the ions to the second axis to be gradually changed along a dimension of the ion guide. Thus, ion focussing or beam confinement can be provided in a straightforward manner Likewise, the ion beam can be wider or less focussed where strong ion focussing is not required.

Optionally, the plurality of electrodes may comprise a 2D (two-dimensional) array of electrodes and wherein progressively fewer electrodes are provided in subsequent electrode rows to progressively decrease the extension. This may provide a simple electrode structure for ion focussing.

Optionally, one or more of the plurality of electrodes may have a length in the dimension and the lengths progressively decrease to progressively decrease the extension. Thus, ion focussing can be provided by a simple or less complex electrode structure.

Optionally, one or more of the plurality of electrodes may have a length parallel to the second axis and the lengths progressively decrease to progressively decrease the extension. Thus, ion focussing can be provided by a simple or less complex electrode structure.

Preferably, the extension may progressively decrease towards the ion outlet. This may allow stronger focussing of the ions towards the ion outlet. This may in turn allow the ions to pass through a smaller exit aperture.

Optionally, the ion guide may further comprise auxiliary DC electrodes configured to focus the deflected ions towards the ion outlet. This may allow finer control of the focussing of ions towards the ion outlet.

Optionally, the DC electrode between the one or more pairs may be a PCB electrode and/or the auxiliary DC electrodes may be PCB electrodes. This may mean that the ion guide is easier to clean and that a larger number and/or higher density of DC electrodes can be provided.

Optionally, the plurality of electrodes may be provided on a first surface comprising a PCB. The DC electrode and/or the auxiliary DC electrodes may be mounted to or positioned above the PCB. Providing the electrodes on a surface comprising a PCB may simplify construction of the ion guide whilst still allowing good control over the ion trajectory in the ion guide.

Optionally, the deflector electrode, one or more of the plurality of electrodes, the DC electrode between the one or more pairs and/or the auxiliary DC electrodes may be configured to receive a constant or pulsed DC voltage to direct the ions along the second axis towards the ion outlet. Thus, ions can thus be directed towards the ion outlet in a number of straightforward manners.

Optionally, the deflector electrode may comprise a plurality of electrodes arranged in a grid. This may allow control of the ion beam in two dimensions. Optionally, the deflector electrode may comprise a plurality of electrodes arranged in a horseshoe configuration. For example, the arrangement may provide a wide DC channel near or at the ion receiving portion and two narrower DC channels. Either configuration may enable the ion guide to be used as a beam switcher, as well as still enabling the ion guide to be used for ion-neutral separation.

Optionally, one or more of the plurality of electrodes may comprise indentations or protrusions or may be wedge-shaped. This may allow stronger confinement of the ions to the second (or another) axis and/or may improve the ability to direct ions towards the ion outlet or another outlet.

Optionally, one or more of the plurality of electrodes may be segmented and each segment may be configured to receive a respective DC voltage. For example, a first series of segments positioned along the same axis may receive a first DC voltage and a second series of segments positioned along the same axis may receive a second DC voltage. The first and second DC voltages may be different. This may provide a simple arrangement for providing one or more ion focussing channels. It will be appreciated that the plurality of electrodes may be segmented in a number of different ways. For example, each of the segments of a particular RF electrode may be the same size (to within a threshold tolerance) or one or more of the segments may be different sizes Likewise, each of the segments may be the same shape (for example, rectangular or wedge-shaped) or one or more of the segments may be different shapes. The one or more of the plurality of electrodes may be segmented into two or more segments. For example, one or more of the plurality of electrodes may have three segments.

Optionally, the ion guide may be configured to compress the ion beam in the direction and/or along an axis perpendicular to the direction through a combination of the DC potential and the RF field. Thus, the ion guide can provide similar functionality to a conventional ion funnel.

Preferably. The ion guide may further comprise an exhaust port aligned with the first axis such that undeflected molecules are ejected from the ion guide via the exhaust port. Thus, the exhaust port may receive and remove most (or all) of the undeflected molecules. This may provide an ion guide capable of separating undesired molecules (for example, neutrals and other adducts) from the ions and removing them from the ion guide in a straightforward manner.

Preferably, the ion guide may be arranged between an atmospheric pressure ion source configured to provide the ions along the first axis and a vacuum chamber for receiving the ejected ions. Thus, the ion guide may provide similar functionality to a conventional ion funnel.

In accordance with a second aspect, there is a method for operating an ion guide, the method comprising steps of:
providing ions along a first axis in the ion guide and ejecting ions from the ion guide along a second axis different from the first axis;
generating a DC potential to deflect ions away from the first axis and towards the second axis; and
generating an RF field via a plurality of electrodes having a substantially planar surface plane parallel to the second axis to direct the deflected ions on to the second axis.

The method may have a number of advantages. For example, the method may be used with an ion guide that is less complex and less expensive to manufacture than a conventional ion guide. Also, the method may provide a less complex manner of separating ions from neutral, adducts and other undesirable molecules.

The methods described above may be implemented as a computer program comprising instructions to operate a computer or computer system. The computer program may be stored on a non-transitory computer-readable medium.

The computer system may include a processor—for example, a central processing unit (CPU). The processor may execute logic in the form of a software program. The computer system may include a memory including volatile and non-volatile storage medium. The different parts of the system may be connected using a network (for example, wireless networks and wired networks). The computer system may include one or more interfaces. The computer system may contain a suitable operating system. For example, the operating system may be UNIX (including Linux) or Windows (RTM), for example.

The above methods may be implemented in a system comprising an analytical instrument and a controller configured to operate the analytical instrument. The analytical instrument may be a mass spectrometer or form part of a mass spectrometer arrangement.

It should be noted that any feature described herein may be used with any particular aspect or embodiment of the invention. Moreover, the combination of any specific apparatus, structural or method features is also provided, even if that combination is not explicitly disclosed.

The invention will now be described with reference to the attached drawings depicting different embodiments thereof, the drawings being provided purely by way of example and not limitation.

### BRIEF DESCRIPTION OF DRAWINGS

The invention may be put into practice in a number of ways, and preferred embodiments will now be described by way of example only and with reference to the accompanying drawings, in which:

FIG. 1 illustrates an embodiment of a device for separating ions from neutral gas jet, the device incorporating a deflector electrode and RF surface;

FIG. 2 shows another embodiment of the device comprising a split deflector electrode;

FIG. 3 shows an example front-on view of the device in FIG. 2;

FIG. 4 illustrates another embodiment of an ion funnel-type device having a curved deflector electrode;

FIG. 5 shows another embodiment of an RF surface device where a distance of the RF surface from a deflector electrode varies along the device;

FIG. 6 illustrates one embodiment of an ion guide having a deflector electrode and an RF surface formed from a plurality of stacked plate electrodes;

FIG. 7 depicts one embodiment in which stacked plate electrodes comprise indentations for narrowing an ion beam;

FIG. 8 illustrates one embodiment of a deflector electrode, in which the deflector electrode is formed from a plurality of DC electrodes arranged in a grid fashion;

FIG. 9 illustrates one embodiment of a deflector electrode, in which the deflector electrode is formed from a plurality of DC electrodes arranged in a horseshoe configuration; and

FIG. 10 illustrates one embodiment of an ion guide having a deflector electrode and an RF surface formed from a plurality of stacked plate electrodes, in which DC electrodes are interspersed between the stacked plate electrodes.

It should be noted that the Figures are illustrated in schematic form for simplicity and are not necessarily drawn to scale. Like features are provided with the same (or similar) reference numerals.

### DESCRIPTION OF PREFERRED EMBODIMENTS

Ion funnels, whilst commonly used for ion capture and transport, have several disadvantages. A particular problem with ion funnels is that neutrals and droplets strike the RF electrodes, contaminating them and causing troubling charging effects. Stacked RF electrodes are also very difficult to clean effectively. In other words, direct injection ion funnels are extremely vulnerable to contamination effects, as the jet from the atmospheric capillary/aperture is directed at electrode surfaces. Orthogonal injection of ions into the funnel is believed to limit the contamination, but this only gives the height of the funnel for ions to migrate out of the gas jet and be captured. The height of the funnel bore being about 10-20 mm, this is a short distance to pull ions out of the gas jet. Sensitivity of the instrument is thus compromised, particularly at high gas flow rates.

Another issue with ion funnels is that, particularly at the aperture exit, stacked ring RF pseudopotentials cease to have a near field-free centre, and DC or gas force is required to drive ions over a series of RF barriers, producing fragmentation and possibly loss of ions.

Furthermore, ion funnels are relatively delicate and complex devices. This makes them relatively expensive to build and maintain.

The present disclosure provides a new ion-funnel-type device that aims to overcome these issues. The ion guide comprises a radio frequency (RF) surface and one or more DC deflector electrodes. The RF surface (which may be termed an “ion carpet” or a plurality of electrodes) is formed from a plurality of electrodes having a substantially planar surface parallel to the second axis and configured to receive RF voltages such that there is a voltage phase difference between adjacent electrodes of the plurality of electrodes. In other words, one or more (or each) of the plurality of electrodes may have a substantially planar face parallel to the second axis. The RF surface may thus generate a substantially planar RF pseudopotential surface parallel to the second axis when receiving the RF voltages. The plurality of electrodes may therefore be considered to collectively have a substantially planar surface parallel to the second axis, even if not all of the plurality of electrodes have a substantially planar face parallel to the second axis. That is, electrodes of the plurality of electrodes having a substantially planar surface may define a plane of the RF surface parallel to the second axis.

The RF surface is preferably substantially planar but need not be completely flat—for example, the electrodes may include indentations or protrusions or be wedge-shaped to direct/compress an ion beam. Ions are urged onto the second axis by a DC electric field produced by the one or more deflector electrodes, whilst neutral molecules are not deflected.

The approach of the present disclosure thus may allow the provision of an ion guide that is less complex and expensive to manufacture than a conventional ion funnel. Furthermore, since the ion guide need not have a stack of RF electrodes, which are hard to clean, the ion guide may be easier to clean than a conventional ion funnel. Similarly, contamination of the RF electrodes and resulting undesired charge effects can be avoided. The device also provides a relatively large distance for ions to be removed from a gas jet, so sensitivity of the ion guide may not be compromised when reducing contamination (in contrast to ion funnels implementing orthogonal injection).

The ion guide design may also advantageously reduce undesired ion fragmentation and loss of ions compared to a conventional ion funnel (in which, particularly at the aperture exit, stacked ring RF pseudopotentials cease to have a near field-free centre, and DC or gas force is required to drive ions over a series of RF barriers, leading to fragmentation and possible loss of ions). For example, ions may be more able to clear the RF barrier from the RF surface, so any DC gradients required at the ion outlet can have a reduced magnitude and undesired ion fragmentation can be reduced. Moreover, the present ion guide design can provide DC lateral focusing of an incident ion beam and can facilitate a greater number and/or higher density of RF electrodes compared to a conventional ion funnel. Being able to provide a greater number and/or higher density of RF electrodes means that the height of the RF barriers along the RF surface can be reduced and, in turn, ion fragmentation can be reduced.

The disclosed ion guide is similar to an ion funnel in a number of respects. For example, the disclosed ion guide is capable of ion beam compression. In particular, the combination of DC potential and RF field in the disclosed ion guide compresses an incident ion beam in one or both directions orthogonal to the axis along which the ions enter the ion guide. The disclosed ion guide is also similar to a conventional ion funnel in that it can (i) efficiently collect ions from the ion source and onwardly transmit them to the next vacuum chamber (typically via an orifice or aperture), and also (ii) separate the collected ions from unwanted neutral molecules that might enter the chamber together with the ions.

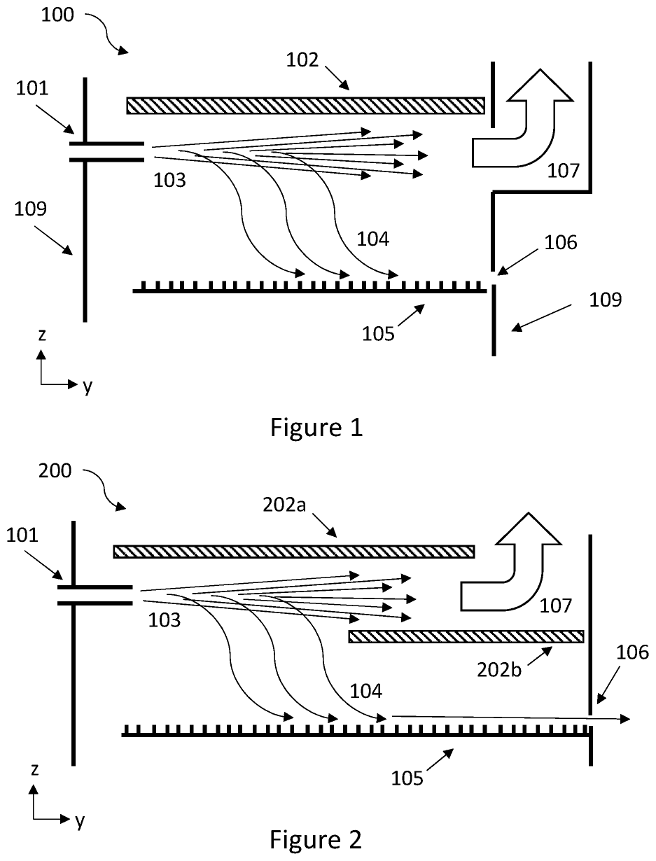

Referring now to FIG. 1, there is illustrated an example schematic layout for an embodiment of an ion guide in accordance with the disclosure. Ions 104 and neutrals are received into an ion receiving portion of the ion guide 100 through an inlet 101 positioned between a deflector electrode 102 and an RF surface 105, which are separated in a first direction. The ion inlet 101 may be an inlet capillary or small aperture, for instance. Pressure inside the device 100 may be between 0.1 to 10 mbar. For example, the operating range of the device 100 may be 2 to 4 mbar.

The first direction may be along a z-axis and may define a height of the device. The height of the device may be between 2 and 5 cm, and most preferably may be 3 cm. Preferably, the length of the device 100 (for instance, extension along a y-axis between walls 109) may be selected based on the gas flow rate and may be between 2 to 20 cm, and may most preferably be 10 cm. The width of the device (extension along an x-axis between sides 309, for example) may be in the range of 1 and 10 cm, most preferably being 5 cm. It will be appreciated that these are exemplary dimensions and the device 100 may have any appropriate dimensions. For example, one advantage of the invention is that the device 100 can be relatively large, so larger dimensions may be used. Furthermore, a device 100 having a larger width may provide a more uniform DC deflection field.

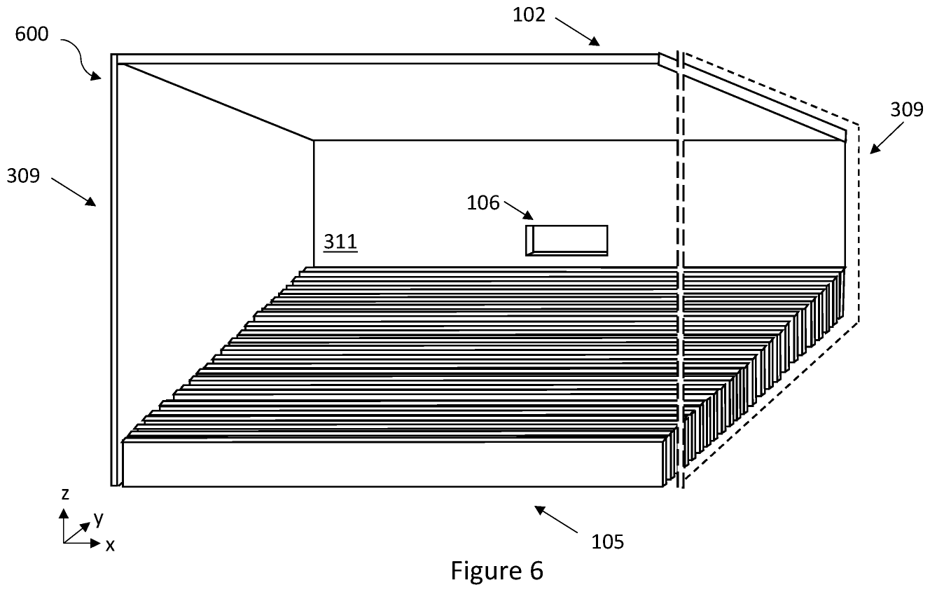

The RF surface may be formed as one of a number of structures that will be discussed below with reference to FIGS. 6, 7 and 10, but is most preferably a series of printed circuit board (PCB) electrodes for ease of cleaning and the ability to provide a large number of RF electrodes. In other words, the plurality of electrodes 105 may be printed on a PCB material. In another example, the plurality of electrodes 105 may be machined electrodes provided on a substrate. In other examples, the electrodes 105 may be formed on a substrate via lithography or etching, for example. The electrodes may have a length extending along the x-axis (that is, along the width of the ion guide 100) and a width along the y-axis.

The inlet 101 may protrude into the volume of the ion guide 100 or may be offset from it (that is, the inlet may not extend into the volume of the ion guide 100). A jet 103 is formed as ions 104 and neutrals enter via the inlet 101. The ions 104 may be urged forward by a gas jet from the capillary and/or by space charge effects. The jet 103 passes through the length of the device 100 and through an aperture to be pumped away via pumping port/exhaust port 107. Since the jet 103 passes over the RF surface 105 and ion outlet 106, neutrals and other unwanted adducts do not contaminate the RF electrodes 105 and can be straightforwardly separated from the ions 104. Ions 104 are pushed out of the jet 103 by a DC gradient produced by DC deflector electrode 102 and eventually settle close to the RF surface 105. Thus, ions 104 are received into the ion guide along a first axis but are pushed off/deflected away from the first axis and towards the RF surface 105, which directs the deflected ions 104 on to a second axis via an RF field. The first and second axes may both be parallel to the y-axis and may be separated in the z-direction.

The electrodes forming the RF surface 105 each have a substantially planar (or planar) face parallel to the second axis, such that ions 104 are directed along the second axis across the plurality of electrodes 105. Thus, in contrast to an ion funnel (in which ions are radially confined and travel along a central bore of the funnel) the ions 104 travel along the second axis in a plane parallel to the substantially planar face. The ions 104 need not be tightly confined to the first and/or second axes. In embodiments, a combination of the DC gradient and RF field may direct ions 104 onto the second axis.

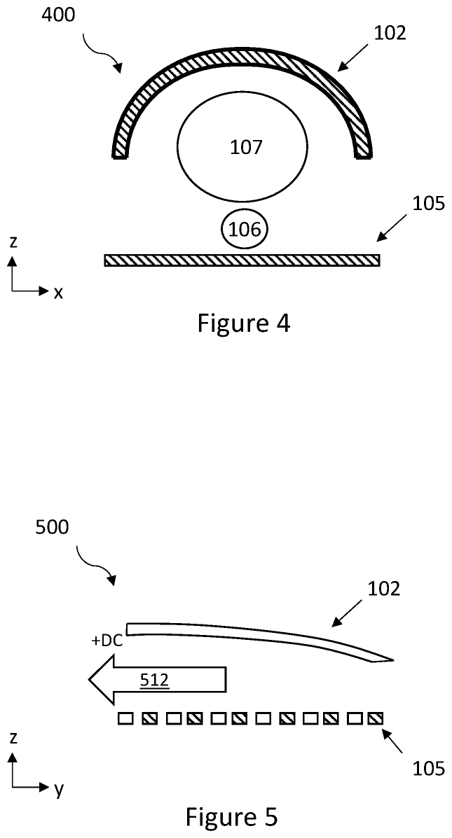

The deflector electrode 102 may be any one of a number of shapes. For example, the deflector electrode 102 may be planar, arcuate (curved), or wedge-shaped. Some shapes may have the advantage of generating additional DC gradients across the device 100. Such shapes are discussed in further detail with reference to FIGS. 4 and 5. The deflector electrode 102 may have a planar surface parallel to the second axis. For example, the deflector electrode 102 may be a plate electrode, the plane of the plate electrode being parallel to the second axis. In another example, the deflector electrode 102 may be arcuate but with a planar section that is parallel to the second axis.

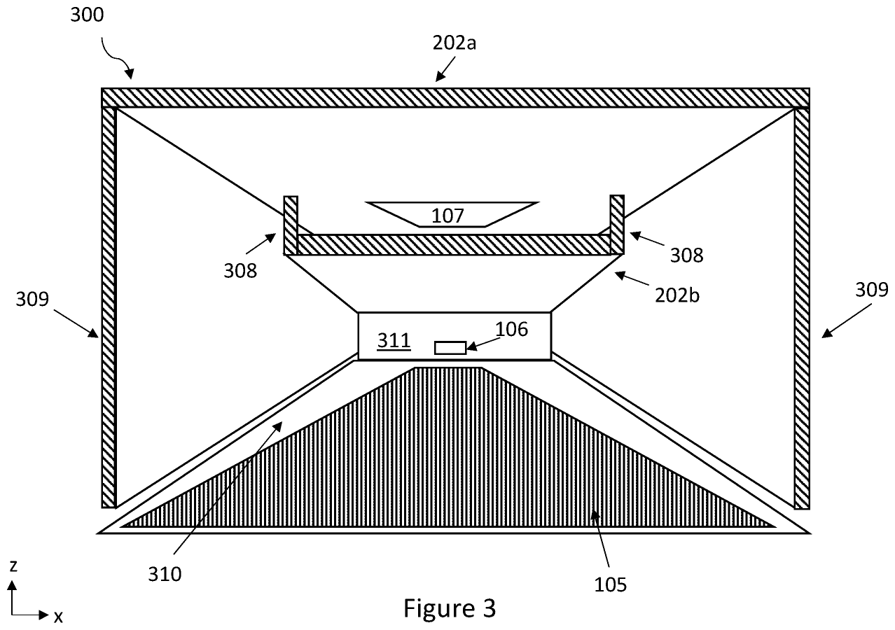

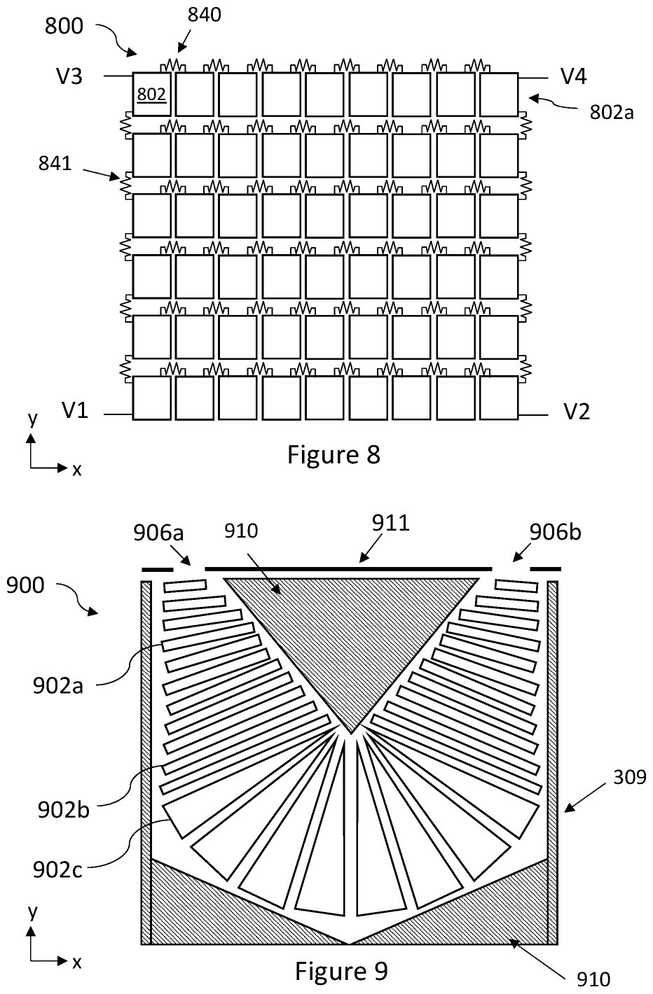

Ions 104 are driven towards the ion outlet 106 (which may also be termed an exit aperture 106), preferably by a DC gradient or travelling wave applied to the RF surface. Superimposed deflector DC gradients (as will be discussed in further detail below with reference to FIGS. 8 and 9) may also or instead be used. The lengths of the electrodes forming the RF surface 105 may vary along the length of the ion guide (for example, progressively decrease towards the ion outlet 106) and/or elements as discussed with reference to FIGS. 3, 7 and 10 may be used to focus ions 104 laterally (along the x-direction) to narrow the beam and pass it through a small exit aperture 106. The sides 309 of the device 100 may be terminated by additional DC electrodes, which may incorporate the deflector voltage. Incorporating a separate voltage may enable variation of the DC field (for example, such that the DC field near the ion outlet 106 is not flattened). It will be appreciated that the device 100 may comprise more than one ion outlet 106 to enable it to be used as an ion beam switching device. In other words, two or more ion outlets 106 may be spaced apart in one direction (for instance, the x-direction) and a DC gradient may be used to switchably direct the ions 104 to a selected ion outlet 106 of the plurality of outlets 106. The polarity of the DC gradient may determine to which ion outlet 106 the ions 104 are guided. Such a DC gradient may be achieved by any one or more of the DC electrodes that will be discussed with reference to FIGS. 8, 9 and 10 or another DC electrode structure.

The design discussed above with reference to FIG. 1, whilst advantageous, has a disadvantage that the deflector electrode 102 is distant from the ions 104 travelling along the RF surface 105, since the distance between the deflector electrode 102 and RF surface 105 should be much larger than the gas jet width. This may weaken the DC field near the exit aperture 106, as the aperture 106 itself interferes with the field, unless it is specially manufactured—for example, by incorporating its own DC field gradient. As ion funnel regions typically operate at around 2 to 4 mbar (and the disclosed devices would operate in a similar range), it is also preferable to have a small exit aperture 106 to limit gas leakage, which requires strong focussing of ions 104. A small exit aperture 106 may be around 1 mm.

Thus, the separation of the deflector electrode 102 and RF surface 105 may be varied along the length of the ion guide 100. For example, deflector electrode 102 may be inclined with respect to the RF surface 105. In another example, the deflector electrode 102 may be shaped such that a portion of the deflector electrode 102 is closer to the RF surface 105 than another portion. The deflector electrode 102 may be curved (arcuate) or stepped, for instance. In yet another example, the single deflector electrode 102 may be split into two deflector electrodes 202a and 202b (or first and second portions/sections 202a and 202b of the deflector electrode 102). The separation between each section of the deflector electrode 102 and the RF surface 105 may vary such that a cross-sectional area defined by the first portion 202b closer to the ion outlet 106 is smaller than that defined by the second portion 202a closer to the ion inlet 101.

With reference to FIG. 2, there is illustrated an example schematic layout for an embodiment of an ion guide 200 which is similar in many respects to the ion guide 100, but addresses the above-mentioned limitations. In this embodiment, the height of the deflector 102 with respect to the RF surface 105 is varied along the length of the device 200 by splitting the single deflector block 102 into two deflector electrodes 202a and 202b. The separation of the deflector electrode 202a from the RF surface 105 is greater than that of deflector electrode 202b from the RF surface 105. The height (separation) of the deflector 102 may be further varied as discussed above (for instance, by inclining the first portion 202a and/or second portion 202b). It will also be appreciated that the deflector 102 could be divided into more than two deflector electrodes. For example, the deflector 102 could be divided into three or more deflector electrodes. This can be used to gradually increase the ion focussing nearer to the ion outlet 106 when the cross-sectional area defined by the three or more deflector electrodes progressively decreases towards the ion outlet 106.

Referring again to FIG. 2, the deflector electrode 202a deflects ions 104 off the first axis and towards RF surface 105 as described with reference to FIG. 1. Ions 104 are thus directed onto the second axis towards the ion outlet 106. Deflector 202b is positioned closer to the RF surface 105 than deflector 202a, such that, when a DC potential is applied to deflector 202b, there is a stronger DC field near the exit aperture 106. Thus, the ions 104 can be better focussed and so pass through a small exit aperture 106.

In other words, the deflector electrode 102 may have a shelf structure comprising the deflector electrode 202a and an inner shelf 202b. The gas jet 103 may pass between the deflector electrode 202a and the inner shelf 202b and be pumped away via pumping port 107. Thus, the ion guide 200 both (i) efficiently collects ions 104 from the ion source and onwardly transmits them to a next vacuum chamber, and also (ii) separates the collected ions 104 from unwanted neutral molecules that may enter the chamber together with the ions 104. That is, the neutral molecules are not transmitted to the next vacuum chamber/downstream element.

The inner shelf 202b may be provided in a number of manners. For instance, the inner shelf 202b may be a separate electrode having a separate DC potential applied to it, a series of electrodes on a PCB, or may be an electrode having the same DC potential as the deflector 202a.

FIG. 3 depicts one exemplary embodiment of an ion guide 300, in which the single large deflector block 102 is made with a shelf structure 202b and comprises a hole 107 for the gas jet 103 to escape through. The deflector electrode 202b may be connected to the deflector electrode 202a by optional side plates 308 that project down from the deflector electrode 202a, as shown in FIG. 3. The RF surface 105 may be provided by electrodes on a PCB and may taper towards the ion outlet 106 in back wall 311. For example, the RF surface 105 may form a substantially triangular or trapeziform/trapezoidal surface, as exemplified in FIG. 3. In another embodiment, back wall 311 may be omitted and ions may instead be transmitted to a downstream element though a region having a gas conductance restriction (that is, a region in which the flow of gas is reduced). The conductance restriction may be provided by RF electrodes 105 that are shorter in the x-direction towards the ion outlet (along the y-axis) such that the ion channel is narrower towards/at the ion outlet 106. The RF electrodes 105 may be progressively shorter in the x-direction, such that the ion channel is progressively narrowed towards the ion outlet 106. Walls may also be provided either side of the reduced length RF electrodes 105, for instance in the manner shown in FIG. 3. The height of the deflector electrode 102 may be reduced towards/at the ion outlet 106, such that the height of the ion channel is also narrower towards/at the ion outlet 106. In other words, there may not be a small exit aperture 106 but there may instead be an ion outlet 106 formed by a narrow and/or long continuation of the RF surface 105.

Repulsive DC-only guard electrodes 310 may be provided on the remaining space on the PCB on both sides of the tapering RF surface to laterally focus the beam (focus the ion beam in a direction perpendicular to the direction of travel). These may be PCB electrodes or electrodes mounted to or above the RF surface. Alternatively or additionally, side wall electrodes 309 may be provided to narrow the ion beam. The same voltage may be applied to the side wall electrodes 309 as is applied to the deflector 102, 202a, 202b. In other words, the side wall electrode 309 may incorporate the deflector voltage. Alternatively or additionally, lateral focusing may be provided by electrodes incorporated into the deflector plate 102 (for instance, as will be discussed with reference to FIGS. 8 and 9). The incorporated electrodes may define a DC channel that is narrower at the ion outlet 106 than at the ion inlet 101. For example, the channel may progressively narrow towards the ion outlet 106.

With reference to FIG. 4, there is illustrated an example schematic layout for an embodiment of an ion guide. As discussed above, deflector 102 may be any number of shapes, and some shapes may advantageously generate additional DC gradients across the device 400. For example, the cross-sectional shape of the deflector 102 may be an open (non-closed) shape. In other words, the cross-sectional shape may not form a closed loop. This may also be referred to as the electrode having an opening or aperture. For example, the electrodes may have an arcuate cross-section. Arcuate electrodes may include horseshoe-shaped electrodes, C-shaped electrodes, U-shaped electrodes, V-shaped electrodes, half-rings, other non-closed rings and/or other pseudo-circular non-closed shapes. For example, deflector 102 may be an arc, as depicted in FIG. 4. Deflector 102 is arced such that it curves around an incident ion beam to laterally compress the beam.

As discussed with reference to FIG. 1, ions 104 enter the ion guide 400 along a first axis. Any neutral molecules continue along the first axis to the pumping port 107 and are pumped out of the ion guide 400. Charged ions 104 are deflected away from the first axis by deflector electrode 102 and towards the second axis. The second axis may be parallel to a plane defined by the RF electrodes 105.

The ions 104 are directed on to the second axis by the RF surface 105 and then along the RF surface 105 by a DC gradient or travelling wave, preferably applied to the RF surface 105. In other examples, the DC gradient may be also or instead applied to auxiliary DC electrodes among the RF electrode 105 or to additional electrodes on the deflector electrode 102. The DC gradient may also direct ions 104 off of the second axis and onto a third or subsequent axis that is separated from the second axis in a second direction perpendicular to the first direction. For example, the first and second axes may be separated in the z-direction and the second and third axes may be separated in the x-direction. This enables the ion guide to switchably direct ions to a selected ion outlet 106 of a plurality of ion outlets.

FIG. 5 illustrates another example schematic layout for an embodiment of an ion guide 500. The distance between the deflector electrode 102 (which may also be termed a “counter electrode”) and the RF surface 105 in the first direction changes as a function of position along the length of the ion guide 500 (along the first and/or second axis). This generates an axial DC gradient 512 (DC gradient along the y-axis) that directs the ions 104 towards the ion outlet 106.

With reference to FIG. 6, there is illustrated an example schematic layout for an embodiment of an ion guide 600, where the pumping port 107 has been omitted for clarity. Although deflector electrode 102 is shown as a single (planar) plate, any of the deflector arrangements discussed above may be used. For example, a shelved deflector electrode 202a, 202b may be used.

As shown in FIG. 6, the RF surface 105 is generated from a stack of RF electrodes 105. There may be more or fewer RF electrodes than shown in FIG. 6. Each of the RF electrodes 105 illustrated in FIG. 6 has a planar surface parallel to the second axis (the surface in the x-y plane). The RF electrodes 105 may comprise elongated electrode plates and may be arranged to be parallel to each other. Alternating RF phases are applied to each electrode 105 in the stack such that there is a voltage phase difference between adjacent electrodes in the stack. The applied RF voltages may be in the range of 20 to 2000V and may have a frequency between 1 to 3 MHz. The thickness and separation of each of the plurality of electrodes may be between 0.5 to 1.5 mm. It will be appreciated that other RF voltages, frequencies, thicknesses and separations may be used. For example, when the RF electrodes 105 comprise PCB printed electrodes (or electrodes formed on a substrate, for example, by lithography), the RF electrodes 105 may be smaller and more closely spaced.

Ions may be guided towards the aperture 106 by a DC gradient superimposed on the deflecting field generated by the deflector electrode 102. The separation of the deflector electrode 102 from the RF surface 105 may also be varied as discussed above to guide ions 104 towards the aperture 106. In another embodiment, the ions 104 may be guided towards the aperture 106 by a DC series provided by linking the stack of RF electrodes with resistors and applying DC voltages between the electrodes, such that a gradient is formed by a series of DC steps between the RF electrodes. In yet another embodiment, a travelling wave (pulsed DC voltage) may be applied to the plurality of RF electrodes 105. Optionally, one direction of guiding force may be provided by the DC gradient provided by the deflector electrode 102 (for instance, along the x axis) and another direction of guiding force may be provided by the DC series/pulsed DC voltage applied to the RF electrodes (for instance, along the y axis). This may be useful when the ion guide 600 has more than one ion outlet 106, as discussed above with reference to FIG. 1.

The guiding force applied by the RF electrodes 105 may depend on the direction in which the RF electrodes 105 are mounted. The RF electrodes 105 may be mounted such that planes of the RF electrodes are parallel to the z-x plane. In another example, the RF electrodes may instead be mounted such that the planes are parallel to the z-y plane. In the latter case, the aperture 106 may be provided in one or both of side walls 309 instead of back wall 311. In other words, the second axis on to which the ions 104 are directed may be perpendicular to the first axis. The ion guide 600 can thus be used to redirect the ions 104. In the example where the aperture 106 is provided in both of side walls 309, the ion guide 600 can be used as a beam switching device as discussed above with reference to FIG. 1.

Guard electrodes 309 are mounted at the sides of the device 600 with a repulsive DC voltage applied to prevent ions 104 from exiting the device 600 via the sides. The side guard voltage may be used together with the DC gradient discussed above to control the maximum displacement of the ions 104 between the guard electrodes 309 (for example, along the x axis). The side guards 309 may also physically close the sides of the device 600 to prevent gas from leaking out of the device 600. Although the side guards 309 in FIG. 6 are depicted as a single electrode plate, the side guards 309 may be a series of PCB electrodes separated by a resistor chain. In other examples, the side guards 309 may not be required where ends of one or more of the RF electrodes 105 extend towards the deflector electrode 102. The extensions may be substantially perpendicular to the lengths of the RF electrodes (for instance, extend in the z-direction) or may be curved to focus ions 104 pushed by the DC field into the sides of the device 600. The extensions may simplify construction of the device or provide better control of output ion beam properties.

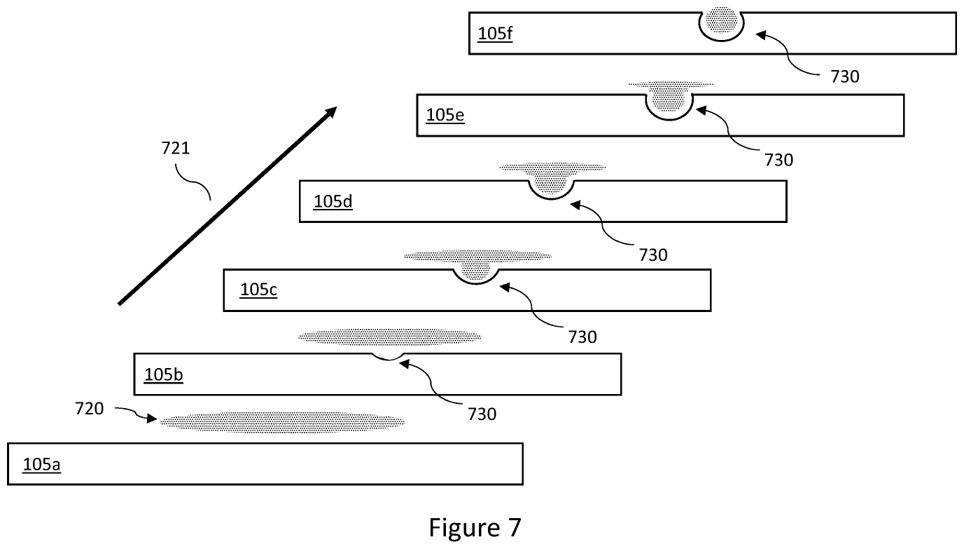

Instead of the tapering RF surface 105 described above, a focussed DC channel may be provided to narrow the ion beam by providing perturbations 730 in the plurality of RF electrodes 105a-105f. Perturbations may be indentations or protrusions, for instance. An example of such RF electrodes 105a-105f is shown in FIG. 7, which may be implemented in any of the ion guides discussed herein. In this example, indentations are provided in the plurality of RF electrodes 105b-105f that progressively increase in size towards an ion outlet 106. The indentations 730 thus form an ion channel. Although electrode 105a is shown as having no indent, it may also comprise an indentation 730, which may be smaller than the indentation 730 in electrode 105b.

More RF electrodes 105 than shown in FIG. 7 may be provided, for example, such that the increase in the sizes of the indents 730 may be more gradual. The indentations 730 are shown as arcs/incomplete circles, but other shapes of indent may be used. For example, the indentations 730 may be triangular/V-shaped.

The ions 104 may be compressed into the indentations by the DC field produced by the deflector electrode. As the indentations progressively increase in size along a direction of travel 721 of the ion beam 720, the ion beam 720 is thus narrowed in focus as more of the ion beam 720 is accommodated into the indents 730. It will be appreciated that when the ion guide comprises more than one ion outlet, more than one ion channel/DC channel may be provided to switchably direct ions 104 to a particular ion outlet by varying a DC potential gradient.

Alternatively, a portion of the plurality of RF electrodes 105a-105f may be segmented. Each series of segments along the direction of travel 721 may have a different DC voltage applied to it to provide an ion focusing channel. Each of the plurality of RF electrode 105a-105f may comprise more than one segmentation to provide more than one ion channel, as discussed above.

FIGS. 8 and 9 illustrate exemplary embodiments of a DC deflector that may be used in combination with any of the ion guides discussed above. In general, the DC deflector plate 102 may comprise a series of DC electrodes to provide lateral focusing of the ion beam and ion transport. In particular, the ion inlet 101 and ion outlet may be separated in a first direction and the DC deflector 102 separated from the RF surface 105 in a second direction perpendicular to the first direction, and the DC deflector may constrain the ion beam in a third direction perpendicular to both the first and second directions. The DC deflector plate 102 may also generate a DC gradient along the first direction to transport ions 104 towards the ion outlet 106 (for example, as discussed in relation to FIG. 5).

With reference to FIG. 8, the DC deflector 800 may comprise a grid of printed electrodes 802 separated by resistors 840, 841. In particular, each printed electrode 802 in a row 802a may be connected to another electrode 802 in the row 802a by a resistor 840. Rows of electrodes 802a may be connected by resistors 841. A respective voltage V1, V2, V3 is applied to electrodes 802 at the corners of the grid. The configuration shown in FIG. 8 produces a diagonal DC gradient.

FIG. 9 shows another example DC deflector 900 that is useful when more than one ion outlet 106 is provided in the ion guide. The DC deflector 900 is made up of electrodes 902a-902c (which may be printed electrodes) arranged to provide a horseshoe-shaped DC channel between two ion outlets 906a and 906b. The channel is least restricted towards the ion inlet end and more restricted towards the ion outlets 906a, 906b. The polarity of the DC gradient may determine which exit aperture 906a, 906b the ions 104 are guided towards. A benefit of the described structure is that ions 104 may be returned from downstream elements (ion optics, for example) via one aperture (for example, aperture 906a) and moved to the other exit aperture (for instance, ion outlet 906b) without the need to change the DC gradient whilst ions 104 are stored within the ion guide 100, 200, 300, 400, 500, 600.

The horseshoe-shaped channel may be provided by an arrangement of triangular 902c and planar 902a, 902b electrodes when viewed in a plan view. Other arrangements may be used to provide the horseshoe-shaped channel. The space surrounding the horseshoe arrangement of DC electrodes (indicated by hatching in FIG. 9) may be configured to contain the ions 104. For example, via a repulsive potential may be used. For example, DC side walls 309 and/or DC guard electrodes 310 may be used as discussed with reference to FIG. 3. Other printed electrodes may be used instead to repel the ions 104.

Alternatively, a DC gradient may be provided perpendicular to both the first direction and the second axis (for example, in one or both directions along the x-axis) by providing auxiliary DC electrodes 1050a to 1050c between the RF electrodes 105 forming the RF surface 105. The ions 104 thus experience a static potential generated by a DC voltage applied to the plurality of RF electrodes 105 and a DC voltage applied to the auxiliary DC electrodes 1050a to 1050c. The potential generated by the auxiliary DC electrodes 1050a to 1050c depends on the height (extension in the z-direction) of the auxiliary DC electrodes 1050a to 1050c relative to the height (extension in the z-direction) of the plurality of RF electrodes 105.

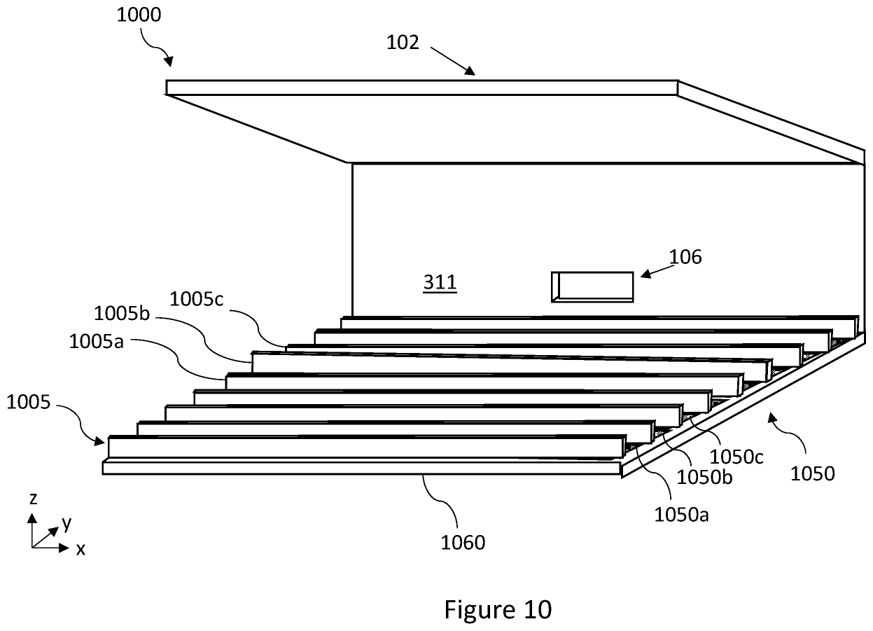

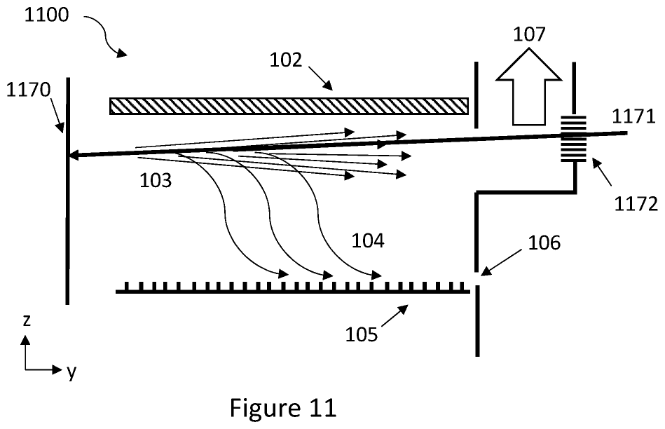

One exemplary embodiment of an ion guide 1000 is shown in FIG. 10. In this embodiment, the auxiliary DC electrodes 1050 (with three exemplary auxiliary DC electrodes labelled as 1050a-1050c) are provided as electrodes printed on a PCB material substrate 1060 and the plurality of RF electrodes 1005 (with three exemplary RF electrodes labelled 1005a-1005c) are mounted on the substrate 1060. One or more of the auxiliary DC electrodes 1050 may be segmented, with segments connected by resistors. Thus, a two-dimensional grid similar to that discussed with reference to FIG. 10 may be provided. Although deflector electrode 102 is shown as a single plate, any of the deflector arrangements discussed above may be used. For example, a shelved deflector electrode 202a, 202b may be used. More than one ion outlet 106 may also be present. The RF electrodes 1005 may comprise perturbations 730 to focus an ion beam, as discussed with reference to FIG. 7.

Alternatively, the auxiliary DC electrodes 1050 may be provided as plate electrodes interspersed between the plurality of RF electrodes 1005. The heights (extension in the z-direction) of the auxiliary DC electrodes 1050 may be progressively varied towards the ion outlet 106 (in the y-direction) to provide a DC gradient that directs ions 104 along the RF surface 1005 towards the ion outlet (along the second axis after the ions 104 have been deflected away from the first axis). In another example, the auxiliary DC electrodes 1050 may be connected by resistors to generate the DC gradient.

Where more than one exit aperture 106 is provided, the heights of one or more auxiliary DC electrodes 1050 may be varied along the length (extension in the x-direction) of the auxiliary DC electrodes 1050 to provide a DC gradient orthogonal to the gradient directing ions 104 towards the exit aperture 106. For example, the auxiliary DC electrodes 1050 may be wedge shaped. The auxiliary DC electrodes 1050 may be a triangular prism, for instance.

Similar to how perturbations can be provided in the RF electrodes 105a-105f, the auxiliary DC electrodes may include perturbations (peaks or troughs/protrusions or indentations) to create channels to improve spatial focussing of the ion beam. For example, a first channel may be defined by a protrusion at one end of the wedge shape (for example, at the higher end of the wedge) and a second channel may be defined by an indentation at another end of the wedge shape (for example, at the lower end of the wedge shape). The channels may be dependent on the polarity of the DC applied to the auxiliary electrode 1050, 1050a-1050c.

FIG. 11 illustrates another embodiment of an ion guide 1100. The ion guide is similar in many respects to that of FIG. 1 and may be used in conjunction with any of the configurations discussed above in respect of FIGS. 2 to 10. In this embodiment, the ion guide is coupled with a MALDI (matrix-assisted laser desorption/ionization) source. The ion guide operates in a manner similar to an ion guide having an atmospheric interface (as shown in FIG. 1, for example) and at similar pressures (for example, 0.1 to 10 mbar, preferably 2 to 4 mbar). However, instead of ions being received into the ion receiving portion via the capillary inlet 101, there is MALDI sample plate 1170. Ions 104 are generated in the ion receiving portion by striking the MALDI plate 1170 with a pulsed laser 1171. The laser may enter the ion guide via a window 1172.

The embodiment illustrated in FIG. 11 may provide similar benefits as discussed above (such as lower contamination of electrodes 102, 105, since fewer droplets strike the electrodes 102, 105 in the ion guide 1100). This configuration may also provide more space to fire the laser 1171 in the ion guide 1100 at a shallow angle compared to conventional ion guides incorporating MALDI. For example, the laser 1171 may strike the sample plate 1170 with an angle of incidence (with respect to the normal of the sample plate 1170) of less than 10°. Optionally, the angle may be less than 5°, less than 3°, or less than 1°.

Firing the laser 1171 at an acute angle may improve sensitivity of the ion guide and/or may produce more ions 104. Furthermore, the ion guide 1100 may be made wide enough that accurate shifting of the laser beam 1171 may replace the usual inaccurate and expensive moving sample stage. In a conventional MALDI setup, the range of travel or movement of the laser is very limited and the entire sample has to be moved by a stage with stepper motors. In contrast, in the present embodiment, the laser 1171 can be moved more accurately as, for example, only a small laser minor (not shown) need be moved. That is, the laser 1171 may be directed to focus at any point on the sample surface 1170 and the laser beam 1171 focus may be redirected in a straightforward manner, for example by moving mirrors that direct the beam 1171.

The methods described herein may be implemented with computer system configurations including hand-held devices, microprocessor systems, microprocessor-based or programmable consumer electronics, minicomputers, mainframe computers and the like. The embodiments can also be practiced in distributed computing environments, where tasks are performed by remote processing devices that are linked through a network.

Certain embodiments can also be embodied as computer-readable code on a non-transitory computer-readable medium. The computer readable medium is any data storage device than can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion. Although embodiments according to the disclosure have been described with reference to particular types of devices and applications (particularly analytical instruments, for example mass spectrometers) and the embodiments have particular advantages in such case, as discussed herein, approaches according to the disclosure may be applied to other types of device and/or application. The specific calibration details of the ion detector, whilst potentially advantageous (especially in view of known calibration constraints and capabilities), may be varied significantly to arrive at devices with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

The methods and apparatus of the present disclosure can be utilised with a variety of electrode structures. Electrodes of appropriate dimensions can be arranged into symmetrical or asymmetrical patterns upon substrates and if elongation of electrodes is beneficial for a particular application, the electrodes may be linear or curving. Individual electrodes can be planar, hemispherical, rectangular or of other shapes. The electrodes may be PCB printed electrodes.

Whilst the ion guide 100, 200, 300, 400, 600, 1000, 1100 has been described as having a height in a z-direction, a length in a y-direction and a width in an x-direction, it will be appreciated that the x-, y- and z-axes may be defined in other manners. For example, an ion guide that is rotated with respect to the ion guide 100, 200, 300, 400, 600, 1000, 1100 shown in the drawings may be provided, without departing from the disclosure. For example, the height of the device may be defined as a distance between the sidewalls 309 (along the x-axis) and the width may be defined as a distance between the RF electrodes 105 and the deflector electrode 102 (along the z-axis).

Furthermore, it will be appreciated that the x-, y- and z-axes are exemplary. For instance, the “height” of the ion guide (distance between the RF electrodes 105 and the deflector electrode 102) may be along the x- or y-axis defined in the drawings Likewise, the “width” of the ion guide (distance between sidewalls 309) may be defined along the z- or y-axis and the “length” of the ion guide (distance between the ion inlet and ion outlet) may be defined along the x- or y-axis.

Although FIGS. 3, 6 and 10 illustrate the plurality of electrodes extending in the x-direction, it will be appreciated that the electrodes could extend in other directions (for example, to change the direction of the guiding force applied by the RF electrodes 105). For example, the plurality of electrodes 105 may be mounted perpendicularly to the mounting illustrated in FIGS. 3, 6 and 10 (that is, each electrode could extend parallel to the second axis). In this case, the extension of the group of the plurality of electrodes 105 as a whole may reduce in one dimension. For example, the central electrodes may be longer than the outer electrodes, such that the width of the collection of the electrodes 105 narrows. In another example, the RF carpet could be formed from a 2D array of electrodes, with a decreasing number of electrodes in electrode rows closer to the ion outlet.

It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (for example, 10%, 20% or 50%) or less than 5% (for example, 2% or 1%).

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an electrode) means “one or more” (for instance, one or more electrodes).

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the invention. That is, an element termed a “first” element (e.g., a first portion 202a) may instead be termed a “second” element (e.g., a second portion 202b) and an element termed a “second” element (e.g., a second portion 202b) may instead be considered a “first” element (e.g., a first portion 202a).

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

All literature and similar materials cited in this application, including but not limited to patents, patent applications, articles, books, treaties and internet web pages are expressly incorporated by reference in their entirety for any purpose. Unless otherwise described, all technical and scientific terms used herein have a meaning as is commonly understood by one of ordinary skill in the art to which the various embodiments described herein belongs.

1. An ion guide comprising:
an ion receiving portion configured to receive ions along a first axis and an ion outlet configured for ejection of ions from the ion guide along a second axis different from the first axis;
a deflector electrode configured to receive a DC potential to deflect ions away from the first axis and towards the second axis; and
a plurality of electrodes having a substantially planar surface parallel to the second axis and configured to receive RF voltages such that there is a voltage phase difference between adjacent electrodes to generate a RF field thereby, the RF field directing the deflected ions on to the second axis towards the ion outlet, wherein the plurality of electrodes is configured to generate a substantially planar RF pseudopotential surface when the RF voltages are received, and
wherein the deflector electrode and the plurality of electrodes are separated in a direction and the ion guide is configured to compress the ion beam in the direction and/or along an axis perpendicular to the direction through a combination of the DC potential and the RF field.

2. The ion guide of claim 1, wherein the separation of the deflector electrode and the plurality of electrodes varies along the ion guide.

3. The ion guide of claim 2, wherein the deflector electrode comprises a first section and a second section and the separation of the first section and the plurality of electrodes is greater than the separation of the second section and the plurality of electrodes.

4. The ion guide of claim 3, wherein the first and second sections are separated in the direction and are provided on either side of the first axis such that undeflected molecules pass between the first section and the second section, and the deflected ions pass between the second section and the plurality of electrodes.

5. The ion guide of claim 2, wherein the deflector electrode is inclined with respect to the plurality of electrodes or the deflector electrode is curved to vary the separation.

6. The ion guide of claim 1, wherein:
the first and second axes are separated in the direction; and/or
the first axis is parallel to the second axis.

7. The ion guide of claim 1, wherein the plurality of electrodes are arranged in a plane parallel to the second axis.

8. The ion guide of claim 1, wherein the deflector electrode is a plate electrode having a plane parallel to the first axis.

9. The ion guide of claim 1, wherein the plurality of electrodes comprise a plurality of stacked electrodes or a plurality of PCB electrodes.

10. The ion guide of claim 1, further comprising a DC electrode between one or more pairs of the plurality of electrodes, wherein the DC electrode is configured to receive a DC potential to direct the ions along the second axis towards the ion outlet.

11. The ion guide of claim 1, wherein an arrangement of the plurality of electrodes extends in a dimension perpendicular to the direction, and wherein the extension of the arrangement progressively decreases.

12. The ion guide of claim 11, wherein:
the plurality of electrodes comprises a 2D array of electrodes and wherein progressively fewer electrodes are provided in subsequent electrode rows to progressively decrease the extension; or
wherein one or more of the plurality of electrodes have a length in the dimension and the lengths progressively decrease to progressively decrease the extension; or
wherein one or more of the plurality of electrodes have a length parallel to the second axis and the lengths progressively decrease to progressively decrease the extension.

13. The ion guide of claim 11, wherein the extension progressively decreases towards the ion outlet.

14. The ion guide of claim 10, further comprising auxiliary DC electrodes configured to focus the deflected ions towards the ion outlet.

15. The ion guide of claim 14, wherein the DC electrode between the one or more pairs is a PCB electrode and/or the auxiliary DC electrodes are PCB electrodes.

16. The ion guide of claim 14 wherein the plurality of electrodes are provided on a first surface comprising a PCB and the DC electrode and/or the auxiliary DC electrodes are mounted to or positioned above the PCB.

17. The ion guide of claim 14, wherein the deflector electrode, one or more of the plurality of electrodes, the DC electrode between the one or more pairs and/or the auxiliary DC electrodes are configured to receive a constant or pulsed DC voltage to direct the ions along the second axis towards the ion outlet.

18. The ion guide of claim 1, wherein one or more of the plurality of electrodes comprise indentations or protrusions or are wedge-shaped.

19. The ion guide of claim 1, wherein one or more of the plurality of electrodes are segmented and each segment is configured to receive a respective DC voltage.

20. The ion guide of claim 1, further comprising an exhaust port aligned with the first axis such that undeflected molecules are ejected from the ion guide via the exhaust port.

21. The ion guide of claim 1, wherein the ion guide is arranged between an atmospheric pressure ion source configured to provide the ions along the first axis and a vacuum chamber for receiving the ejected ions.

22. A method for operating an ion guide, the method comprising steps of:
providing ions along a first axis in the ion guide and ejecting ions from the ion guide along a second axis different from the first axis;
generating a DC potential to deflect ions away from the first axis and towards the second axis; and
generating an RF field via a plurality of electrodes having a substantially planar surface plane parallel to the second axis to direct the deflected ions on to the second axis.

23. A system comprising an analytical instrument and a controller configured to operate the analytical instrument according to claim 22.

24. A computer-readable medium comprising instructions that, when executed, cause a computing device operating an analytical instrument to perform the steps of claim 22.
